(19) United States
(12) Patent Application Publication
(10) Pub. No.: US 2024/0354139 A1
(43) Pub. Date: Oct. 24, 2024

(54) LOW-LATENCY VIRTUAL MACHINES

(71) Applicant: Microsoft Technology Licensing, LLC, Redmond, WA (US)

(72) Inventors: Bruce J. SHERWIN, JR., Woodinville, WA (US); Yimin DENG, Redmond, WA (US)

(21) Appl. No.: 18/302,706

(22) Filed: Apr. 18, 2023

(51) Int. Cl. G06F 9/455

(52) U.S. Cl. CPC G06F 9/45558; G06F 2009/45562; G06F 2009/4557

(57) ABSTRACT

Managing a processor idle state based on a virtual machine (VM) executing at the processor system. A device may determine that a VM possesses a performance entitlement. The device may associate a virtual processor core of the VM with a physical processor core, including disabling a processor idle state at the physical processor core based on the VM possessing the performance entitlement. The device may disassociate the virtual processor core from the physical processor core, including enabling the processor idle state at the physical processor core.

### BACKGROUND OF THE INVENTION

Modern central processing units (CPUs), or processors, support a variety of processor power management technologies, including energy-saving states-known as processor idle states—that reduce CPU power consumption when the CPU is idle (e.g., not actively executing instructions). For example, the Advanced Configuration and Power Interface (ACPI) specification defines a variety of processor idle states, known as “C-states” (sometimes referred to as “C-modes”), as well as interfaces that an operating system (OS) can use to instruct a CPU to enter various C-states. C-states are states when the CPU has reduced, or turned off, selected functions. Different processors support different numbers of C-states in which various parts of the CPU are turned off. Generally, a higher numbered C-state is a “deeper” idle state that turns off more parts of the CPU, while a lower numbered C-state is a “lighter” idle state that turns off fewer parts of the CPU. Deeper idle states can significantly reduce power consumption by the CPU, as compared to lighter idle states. While the C-states implemented by a given CPU may vary, some basic C-states defined by the ACPI specification, and supported by most contemporary processors, are outlined in Table 1:

TABLE 1

| State | Known As | Description |
|---|---|---|
| C0 | Operating State | The CPU is fully turned on |
| C1 | Halt | The CPU processor is not executing instructions, |
| | | but it can return to an executing state essentially |
| | | instantaneously. This state stops CPU main |
| | | internal clocks via software while a bus |
| | | interface unit and an advanced programmable |
| | | interrupt controller (APIC) are kept |
| | | running at full speed |
| C2 | Stop-Clock | The CPU maintains all software-visible state but |
| | | may take longer to wake up. This state stops CPU |
| | | main internal clocks via software and reduces |
| | | CPU voltage while the bus interface unit |
| | | and APIC are kept running at full speed |
| C3 | Sleep | The CPU does not need to keep its cache coherent |
| | | but maintains other state. Some CPUs have |
| | | variations on the C3 state (Deep Sleep, |
| | | Deeper Sleep, etc.) that differ in how |
| | | long it takes to wake the processor. |
| | | This state stops all CPU internal clocks. |

Some processor manufacturers define additional C-states, which may vary by processor model. For example, contemporary processors from INTEL CORPORATION of Santa Clara, California have C-states up to C10, where the processor distinguishes core states (e.g., states of individual CPU cores) and package states (e.g., groupings of CPU cores within the same processor package).

Additionally, hypervisor-based virtualization technologies allocate portions of a computer system's physical resources (e.g., processor cores, physical memory regions, storage resources) into separate partitions, and execute software within each of those partitions. Hypervisor-based virtualization technologies, therefore, facilitate the creation of virtual machines (VMs) that each executes guest software, such as an OS and other software executing therein. A computer system that hosts VMs is commonly called a VM host (sometimes referred to as a “VM host node”). While hypervisor-based virtualization technologies can take a variety of forms, many use an architecture comprising a hypervisor that has direct access to hardware and that operates in a separate execution environment from all other software in the system, a host partition that executes a host OS and a host virtualization stack, and one or more guest partitions corresponding to VMs. The host virtualization stack within the host partition manages guest partitions, and thus the hypervisor grants the host partition a greater level of access to the hypervisor, and to hardware resources, than it does to guest partitions.

Virtualization service providers operate a plurality of VM hosts, in order to provide VM hosting services to a plurality of tenants. In doing so, virtualization service providers may collocate VMs from a plurality of tenants at a single VM host. Examples of virtualization service providers include AZURE operated by MICROSOFT CORPORATION of Redmond, Washington; AMAZON WEB SERVICES (AWS) operated by AMAZON, INC. Seattle, Washington; and GOOGLE CLOUD PLATFORM (GCP) operated by GOOGLE LLC of Mountain View, California.

The subject matter claimed herein is not limited to embodiments that solve any disadvantages or that operate only in environments such as those described above. Rather, this background is only provided to illustrate one example technology area where some embodiments described herein may be practiced.

### SUMMARY OF THE INVENTION

In some aspects, the techniques described herein relate to methods, systems, and computer program products for managing a processor idle state based on a virtual machine (VM) executing at a processor system, including: determining that a VM possesses a performance entitlement; associating a virtual processor core of the VM with a physical processor core, including disabling a processor idle state at the physical processor core based on the VM possessing the performance entitlement; and disassociating the virtual processor core from the physical processor core, including enabling the processor idle state at the physical processor core.

In some aspects, the techniques described herein relate to methods, systems, and computer program products for managing a processor idle state based on a virtual machine (VM) executing at a processor system, including: associating a first virtual processor core of a first VM with a physical processor core of the processor system, including disabling a processor idle state at the physical processor core based on the first VM possessing a performance entitlement; subsequent to disabling the processor idle state at the physical processor core, disassociating the first virtual processor core from the physical processor core, including enabling the processor idle state at the physical processor core; and subsequent to disassociating the first virtual processor core from the physical processor core, associating a second virtual processor core of a second VM with the physical processor core without disabling the processor idle state at the physical processor core based on the second VM lacking the performance entitlement.

In some aspects, the techniques described herein relate to methods, systems, and computer program products for managing a processor idle state based on a virtual machine (VM) executing at a processor system, including: based on a first VM possessing a performance entitlement: associating a first virtual processor core of the first VM with a first physical processor core of the processor system, including disabling a processor idle state at the first physical processor core, and subsequent to disabling the processor idle state at the first physical processor core, disassociating the first virtual processor core from the first physical processor core, including enabling the processor idle state at the first physical processor core; and associating a second virtual processor core of a second VM with a second physical processor core of the processor system without disabling the processor idle state at the second physical processor core based on the second VM lacking the performance entitlement.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the advantages and features of the systems and methods described herein can be obtained, a more particular description of the embodiments briefly described above will be rendered by reference to specific embodiments thereof which are illustrated in the appended drawings. Understanding that these drawings depict only typical embodiments of the systems and methods described herein, and are not therefore to be considered to be limiting of their scope, certain systems and methods will be described and explained with additional specificity and detail through the use of the accompanying drawings in which:

FIG. 1A illustrates an example computer architecture that facilitates operation of low-latency virtual machines (VMs);

FIG. 1B illustrates an example showing an association between a virtual core from a low-latency VM (LLVM) and a physical core with an idle state disabled, and an association between a virtual core from a conventional VM and a physical core with the idle state enabled;

FIG. 1C illustrates an example showing a disassociation between a virtual core from an LLVM and a physical core;

FIG. 1D illustrates an example showing a re-association of a virtual core from a conventional VM with a different physical core;

FIG. 1E illustrates an example showing an LLVM that has virtual processors associated with a mix of physical cores having an idle state enabled and disabled;

FIG. 2 illustrates an example of a processor manager component;

FIG. 3A illustrates a flow chart of an example of a method for managing a processor idle state based on a VM executing at the processor system;

FIG. 3B illustrates a flow chart of another example of a method for managing a processor idle state based on a VM executing at the processor system; and

FIG. 4 illustrates a flow chart of another example of a method for managing a processor idle state based on a VM executing at the processor system.

### DETAILED DESCRIPTION OF THE INVENTION

Virtualization service providers often configure hypervisors to enable a processor idle state (e.g., a C-state) at virtual machine (VM) host processor(s), such that the processor(s) enter an idle state when not actively executing guest workloads. For example, a processor with an idle state enabled may enter an idle state, such as a deep state (e.g., C3 or higher), when that processor is not actively executing instructions on behalf of any VM's virtual processor. This has the advantage of reducing energy consumption by the VM host's processor(s). This also has the advantage of reducing heat production by the VM host's processor(s), thereby reducing cooling needs. When these advantages are considered, configuring hypervisors to utilize a processor idle state at VM hosts can conserve considerable energy resources. This is particularly true for data centers containing many VM hosts.

Despite the benefits of enabling a processor idle state at VM host processors, it can be advantageous to disable one or more processor idle states at VM host processors. In particular, while the use of a processor idle state conserves energy resources, its use introduces latency into guest workloads. For example, when a VM host's physical processor is in an idle state, and particularly a deep sleep state, it takes time for the physical processor to “wake” from the idle state and begin executing instructions on behalf of the VM's virtual processor. The latency introduced by a processor waking from an idle state is generally in the range of microseconds to milliseconds, but this can vary depending on the processor and the depth of the idle state. While this amount of latency may seem negligible in terms of human perception, and may be acceptable for many guest computing workloads, it can have a significant detrimental effect on other guest computing workloads. For example, some computing workloads (e.g., database operations, audio and/or video streaming) can be very latency-sensitive. When these workloads are performed by VMs executing at VM hosts that make use of a processor idle state, the latency introduced by the use of this idle state can lead to unsatisfactory results. The detrimental effects of the use of an idle state are amplified if the processor enters an idle state more frequently, and/or by use of deeper idle states.

Thus, there is a conflict between the use of a processor idle state at VM hosts in order to conserve energy resources, and the detrimental effects use of that idle state can have on the guest workloads of VMs executing at those VM hosts. This is particularly the case for latency-sensitive guest workloads. To overcome these conflicts, the embodiments herein configure a hypervisor to control the use of one or more idle states at VM host processors depending on which VM is utilizing a given host processor. In embodiments, a hypervisor determines to which VM a virtual processor belongs. Then, based on entitlements for that VM, the hypervisor enables or disables one or more idle states at a physical processor to which the virtual processor is associated. In embodiments, the hypervisor disables one or more idle states (e.g., all idle states, deep sleep ide states) if the virtual processor belongs to a VM with a performance entitlement and enables those idle state(s) if the virtual processor belongs to a VM without that performance entitlement. In embodiments, this performance entitlement is a “low-latency entitlement” signaling that an associated VM is a “low-latency” VM (LLVM). In embodiments, a low-latency entitlement is associated with a particular VM and indicates that idle states at a physical processor can be disabled when that VM's virtual processor is associated therewith.

For example, if a first virtual processor belongs to an LLVM, in embodiments a hypervisor disables one or more idle state(s) at a VM host's physical processor when associating that first virtual processor with the physical processor. In contrast, if a second virtual processor belongs to a conventional VM that lacks a low-latency entitlement, then the hypervisor leaves those idle state(s) enabled at the VM host's physical processor (or enables those idle state(s) if disabled) when associating that second virtual processor with the physical processor.

Some embodiments operate at the granularity of individual processor cores. For example, continuing the previous example, when disabling idle state(s) based on associating the first virtual processor with the VM host's physical processor, the hypervisor disables those idle state(s) at a core of the physical processor to which the first virtual processor is associated. In embodiments, the hypervisor re-enables those idle state(s) when the first virtual processor is disassociated from the core. Similarly, when associating the second virtual processor with the VM host's physical processor, the hypervisor considers a core of the physical processor to which the second virtual processor is associated when leaving idle state(s) enabled, or enabling idle state(s) if they are disabled.

In embodiments, a VM can be granted a low-latency entitlement, but only utilize that entitlement for a subset of its virtual processors. In these embodiments, the hypervisor disables idle state(s) for a subset of the LLVM's virtual processors, but enables idle state(s) for a different subset of the LLVM's virtual processors. In one example, the hypervisor utilizes a “big.little” processor configuration to expose one virtual processor to an LLVM as a “performance” core that the hypervisor associates with a physical core that has idle state(s) disabled, and to expose another virtual processor to the LLVM as an “efficiency” core that the hypervisor associates with a physical core that has idle state(s) enabled.

By configuring a hypervisor to control the use of idle state(s) at VM host processors on a per-VM basis, the embodiments herein resolve the conflict between the use of processor idle state(s) to conserve energy resources, and the detrimental effects disabling processor idle state(s) can have on guest workloads. In particular, a hypervisor implemented according to the embodiments herein can enable idle state(s) for VMs whose workloads are compatible with the latency introduced by idle state(s) (e.g., VMs lacking a low-latency entitlement). This conserves energy resources when executing those VM's virtual processors. A hypervisor implemented according to the embodiments herein can also disable a subset of idle states for LLVMs, whose workloads are latency-sensitive. This reduces the latency of execution of LLVM workloads. Thus, a single VM host with a diverse mix of VMs (e.g., LLVMs with low-latency entitlements and conventional VMs without low-latency entitlements) is capable of both energy conservation and performance preservation.

In addition to the foregoing technical benefits, the embodiments herein offer virtualization service providers unique VM host management capabilities. From the perspective of an individual VM host, in an embodiment, a hypervisor associates a virtual processor from a conventional VM with a first processor core at the VM host, while enabling one or more idle states (e.g., a deep sleep idle state) at the first processor core. In this embodiment, the hypervisor also associates a virtual processor from an LLVM with a different but “nearby” second processor core at the VM host, while disabling one or more idle states (e.g., the deep sleep idle state) at the second processor core. In embodiments, “nearby” processor cores are thermally-linked, such as by being on the same processor die, on the same socket, and the like. Enabling idle state(s) at the first processor core reduces the amount of heat generated by the first processor core. At the same time, disabling idle state(s) at the nearby second processor core, coupled with the reduced heat generation by the first processor core, gives the second processor core an increased chance to utilize higher clock rates than would be otherwise possible if the first processor core had idle state(s) disabled. For example, the second processor core may be able to take advantage of frequency scaling technologies, such as TURBOBOOST from INTEL, whereby a processor operates at a base clock rate but can “boost” to higher clock rates when workloads and thermal conditions permit.

In addition, from the perspective of a data center containing many VM hosts, in some embodiments a virtualization service provider manages a mix of LLVMs and conventional VMs based on available energy resources (e.g., within a single data center or across data centers), based on cooling needs and capabilities, and the like. In one example, a virtualization service provider caps the number of LLVMs that can operate per rack, per row, per region, etc., because of available energy resources and/or cooling capability. In another example, a virtualization service provider migrates LLVMs to data centers with increased energy availability, lower energy cost, higher renewable energy generation capability, increased cooling capability, favorable weather conditions, etc.

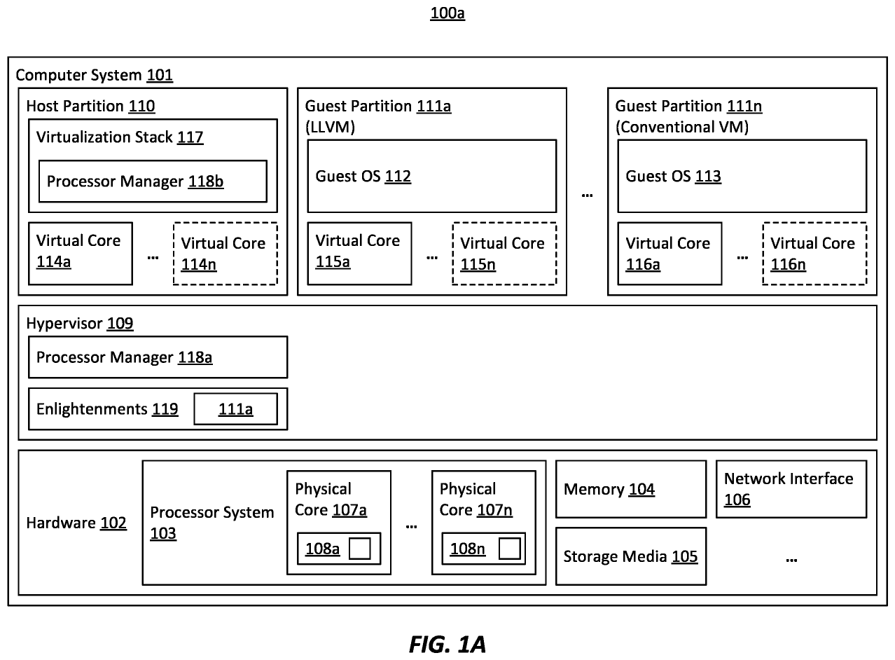

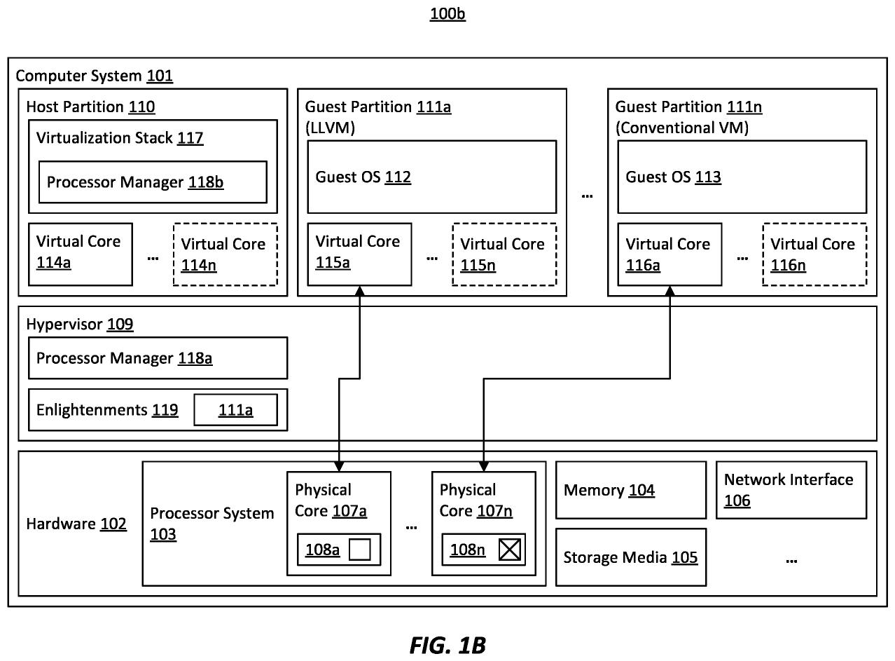

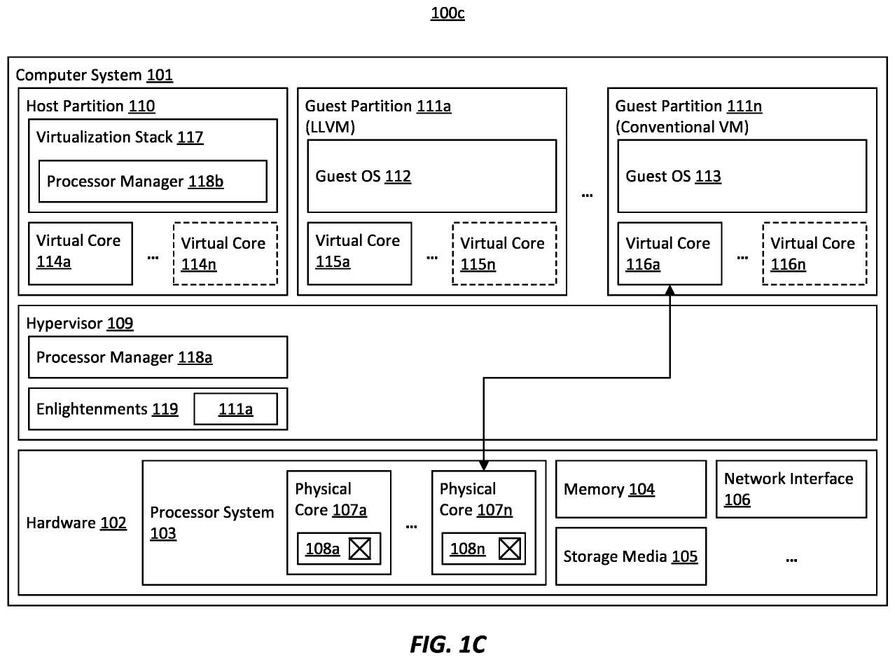

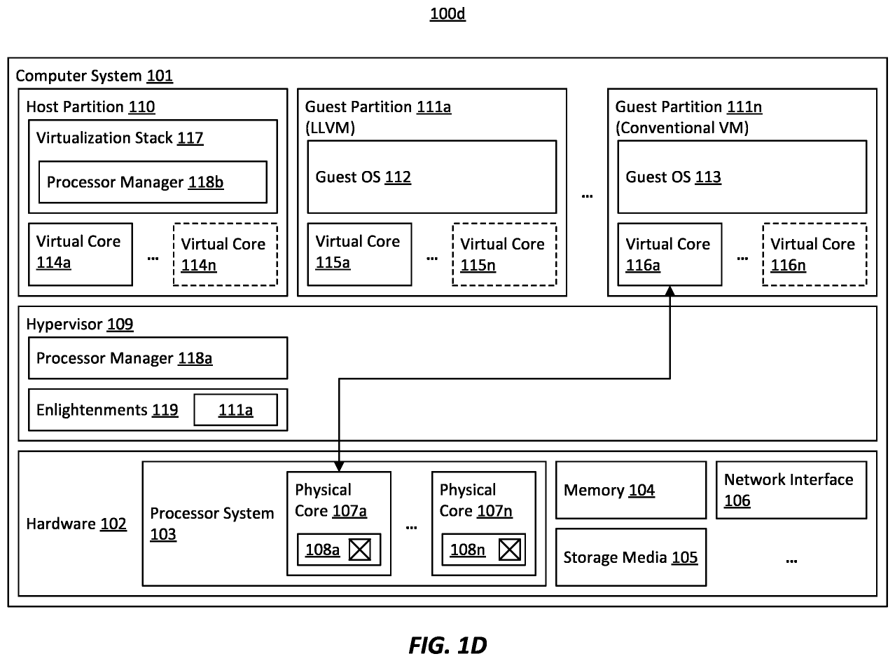

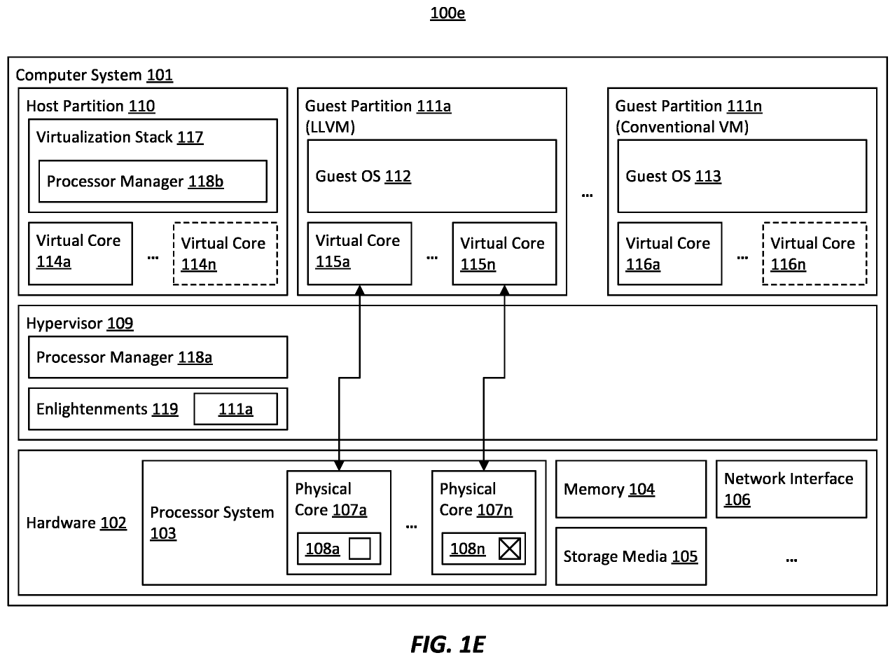

FIG. 1A illustrates an example 100a of a computer architecture that facilitates the operation of LLVMs. In example 100a, the computer architecture includes a computer system 101 comprising hardware 102. Illustrated examples of hardware 102 include a processor system 103. In embodiments, processor system 103 is a single central processing unit (CPU) comprising one or more processors (e.g., CPU cores), or a plurality of CPUs which each comprise one or more CPU cores. Regardless of the arrangement of processor system 103, in FIG. 1A, processor system 103 includes a plurality of CPU cores, illustrated as physical cores 107 (e.g., physical core 107a to physical core 107n, with an ellipsis indicating that there could be any number of physical cores 107).

Illustrated examples of hardware 102 also include a memory 104 (e.g., system or main memory), a storage media 105 (e.g., a single computer-readable storage medium, or a plurality of computer-readable storage media), and a network interface 106 (e.g., one or more network interface cards). Although not shown, other examples of hardware 102 include a trusted platform module (TPM) for facilitating measured boot features, an input/output (I/O) memory management unit (IOMMU) that connects a direct memory access (DMA)-capable I/O bus (and any devices connected thereto) to memory 104, a graphics processing unit (GPU) for rendering image data, a video display interface for connecting to display hardware, a user input interface for connecting to user input devices, an external bus for connecting to external devices, and the like.

As illustrated, in example 100a a hypervisor 109 executes directly on hardware 102. In general, hypervisor 109 partitions hardware resources (e.g., processor system 103, memory 104, I/O resources) into a plurality of partitions. In embodiments, these partitions include a host partition 110 within which a host OS (not illustrated) executes. In embodiments, these partitions also include guest partitions 111 within which guest OSs execute (e.g., guest partition 111a executing guest OS 112 to guest partition 111n executing guest OS 113, with an ellipsis indicating that hypervisor 109 could operate any number of guest partitions).

As illustrated, host partition 110 includes a virtualization stack 117, which uses application program interface (API) calls (e.g., hypercalls) to hypervisor 109 to create, manage, and destroy guest partitions 111. In embodiments, virtualization stack 117 makes decisions about which portion(s) of memory 104 to allocate to each guest partition, operates para-virtualized drivers that multiplex guest partition access to physical hardware devices (e.g., storage media 105, network interface 106), and facilities limited communications among partitions via a VM bus, among other things.

In embodiments, hypervisor 109 creates one or more virtual processors for each partition. For example, FIG. 1A illustrates host partition 110 as including virtual cores 114 (e.g., virtual core 114a to virtual core 114n, with an ellipsis indicating that there could be any number of virtual cores 114), illustrates guest partition 111a as including virtual cores 115 (e.g., virtual core 115a to virtual core 115n, with an ellipsis indicating that there could be any number of virtual cores 115), and illustrates guest partition 111n as including virtual cores 116 (e.g., virtual core 116a to virtual core 116n, with an ellipsis indicating that there could be any number of virtual cores 116). In embodiments, hypervisor 109 uses a processor manager 118 to manage the use of processor system 103 (e.g., physical cores 107) by these virtual processors. In embodiments, hypervisor 109 coordinates with virtualization stack 117 in managing the use of processor system 103 by virtual processors. Thus, in FIG. 1A, processor manager 118 is illustrated as being split between hypervisor 109 (processor manager 118a) and virtualization stack 117 (processor manager 118b).

In embodiments, hypervisor 109 also allocates a portion of memory 104 to each partition, and intercepts and routes interrupts generated by each partition, among other things. In embodiments, hypervisor 109 uses second-level address translation (SLAT) to isolate memory allocated to each partition created by hypervisor 109 from other partition(s) created by hypervisor 109. For example, hypervisor 109 may use one or more SLAT tables, to map system physical addresses (SPAs) in memory 104 to guest physical addresses (GPAs) that make up each partition's memory space.

In embodiments, physical cores 107 are capable of entering various idle states, such as a number of C-states. In embodiments, a configuration of which idle state(s) are enabled or disabled can be controlled on a per-core basis. In one example, idle state(s) are enabled or disabled for a physical core by writing to a processor register at that core. In FIG. 1A, an idle state configuration for each physical core of physical cores 107 is denoted by an idle state setting 108 (e.g., idle state setting 108a for physical core 107a to idle state setting 108n for physical core 107n). While, for simplicity, each idle state setting 108 is illustrated as being binary (e.g., enabled when the corresponding box is checked, or disabled when the corresponding box is not checked), in embodiments idle state settings of a physical core are more granular, such as with a specification of permitted (or denied) idle state(s) for the physical core. As one example, an idle state setting could specify that certain C-states (e.g., less than C3) are enabled for the physical core, while other C-states (e.g., C3 or greater) are disabled for the physical core.

In embodiments, processor manager 118 controls the use of idle state(s) at processor system 103 (e.g., physical cores 107) on a per-VM (guest partition) basis. In embodiments, a guest partition can be granted a performance entitlement, such as an entitlement as being an LLVM that can execute on at least one physical core of physical cores 107 with at least a subset of idle states being disabled at that physical core. In FIG. 1A, hypervisor 109 stores, or otherwise accesses (e.g., from virtualization stack 117), a set of enlightenments 119 that specify which guest partition(s) possess a performance entitlement. In FIG. 1A, enlightenments 119 specify that guest partition 111a possesses a performance entitlement, and thus guest partition 111a is indicated as being an LLVM. In contrast, enlightenments 119 do not specify that guest partition 111n possesses a performance entitlement, and thus guest partition 111n is indicated as being a conventional VM.

In embodiments, when associating a guest partition's virtual core (e.g., virtual cores 115, virtual cores 116) with a physical core of physical cores 107, processor manager 118 determines to which guest partition that virtual core belongs. Then, based on knowledge of enlightenments 119, processor manager 118 configures an idle state setting 108 at the physical core. In embodiments, processor manager 118 disables idle states (or a subset thereof, such as C3 and higher) at the physical core if the virtual processor belongs to a guest partition with a low-latency entitlement (e.g., guest partition 111a). In addition, in embodiments, when later disassociating that virtual core from the physical core, processor manager 118 enables the previously disabled idle state(s). In embodiments, if the virtual processor belongs to a guest partition without a low-latency entitlement (e.g., guest partition 111n), then processor manager 118 retains an existing idle state setting, or expressly enables idle states (or a subset thereof, such as C3 and higher) at the physical core if they are disabled.

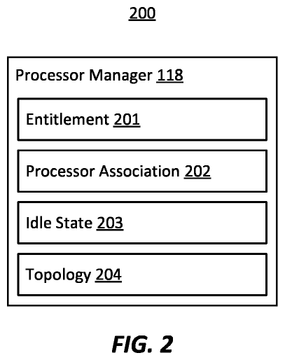

FIG. 2 illustrates an example 200 of processor manager 118. Each internal component of processor manager 118 depicted in FIG. 2 represents various functionalities that processor manager 118 might implement in accordance with various embodiments described herein. It will be appreciated, however, that the depicted components-including their identity and arrangement—are presented merely as an aid in describing example embodiments of processor manager 118. In particular, it is noted that, in various implementations, the component of processor manager 118 could be variously arranged between hypervisor 109 (e.g., processor manager 118a) and virtualization stack 117 (e.g., processor manager 118b).

Processor manager 118 is illustrated as including an entitlement component 201, which manages a record of enlightenments 119 for guest partitions 111. For example, based on a tenant's contract, a virtualization service provider may grant guest partition 111a a low-latency entitlement. Processor manager 118 also utilizes entitlement component 201 to determine if a given guest partition possesses a performance entitlement, such as a low-latency entitlement.

Processor manager 118 is also illustrated as including a processor association component 202, which manages the association and disassociation of individual virtual processors (e.g., virtual cores 114, virtual cores 115, virtual cores 116) with individual physical processors (e.g., physical cores 107). In connection with the operation of processor association component 202, an idle state component 203, manages an idle state setting for a destination physical core. In embodiments, this is based on which guest partition of guest partitions 111 a corresponding virtual processor belongs to, and whether or not that guest partition has a performance entitlement within enlightenments 119. In various embodiments, idle state component 203 manages an idle state setting at a physical core prior to, concurrent with, or after processor association component 202 has made a virtual-to-physical core association or disassociation.

In some embodiments, processor manager 118 also includes a topology component 204, which manages a topology of virtual cores, as presented to a guest partition. In one example, topology component 204 presents a virtual core to a guest partition as a performance core when that virtual core is associated with a physical core that has an idle state disabled, and presents a virtual core to the guest partition as an efficiency core when that virtual core is associated with a physical core that has the idle state enabled. In embodiments, a guest OS (e.g., guest OS 112) manages the scheduling of processing tasks (e.g., processes, threads) at virtual cores based on whether those virtual cores are presented to the guest OS as performance cores or efficiency cores. For example, the guest OS may schedule a higher-priority and/or latency-sensitive workload to a performance core, and may schedule a lower-priority and/or latency tolerant workload to an efficiency core.

Examples of the operation of processor manager 118 are now provided in connection with FIGS. 1B-1E. Initially, FIG. 1B illustrates an example 100b, showing an association between a virtual core from an LLVM and a physical core with an idle state disabled, and an association between a virtual core from a conventional VM and a physical core with the idle state enabled. In example 100b, processor association component 202 has associated virtual core 115a with physical core 107a. In connection with this association, and based on guest partition 111a possessing a performance entitlement (e.g., as shown in enlightenments 119), idle state component 203 has disabled an idle state at physical core 107a (e.g., the box within idle state setting 108a is not checked). Additionally, in example 100b, processor association component 202 has associated virtual core 116a with physical core 107n. Based on guest partition 111n lacking a performance entitlement (enlightenments 119), an idle state is enabled at physical core 107n (e.g., the box within idle state setting 108n is checked). In embodiments, idle state component 203 has preserved a prior “enabled” idle state within idle state setting 108n, or has expressly enabled an idle state within idle state setting 108n.

FIG. 1C illustrates an example 100c showing a disassociation between a virtual core from an LLVM and a physical core. In example 100c, which chronologically follows after example 100b, processor association component 202 now disassociated virtual core 115a from physical core 107a. In connection with this disassociation, and based on guest partition 111a possessing a performance entitlement (e.g., as shown in enlightenments 119), idle state component 203 has re-enabled an idle state at physical core 107a (e.g., the box within idle state setting 108a is now checked).

FIG. 1D illustrates an example 100d showing a re-association of a virtual core from a conventional VM with a different physical core. In example 100d, which chronologically follows after example 100c, processor association component 202 now disassociated virtual core 115a from physical core 107n, and associated it with physical core 107a. In connection with the disassociation, an idle state has remained enabled at physical core 107n (e.g., the box within idle state setting 108n remains checked). In addition, in connection with the association, an idle state has also remained enabled at physical core 107a (e.g., the box within idle state setting 108a remains checked).

FIG. 1E illustrates an example 100e showing an LLVM that has virtual processors associated with a mix of physical cores having an idle state enabled and disabled. In example 100d, virtual core 115a is associated with physical core 107a, with an idle state disabled. Additionally, in example 100d, virtual core 115n is associated with physical core 107n, with an idle state enabled. In embodiments, using a “big.little” processor configuration, topology component 204 presents virtual core 115a to guest OS 112 as a performance core, and presents virtual core 115n to guest OS 112 as an efficiency core. Thus, in embodiments, guest OS 112 schedules higher-priority and/or latency-sensitive workloads to virtual core 115a where they are processed by physical core 107a with the idle state disabled, and schedules lower-priority and/or latency tolerant workloads to virtual core 115n where they are processed by physical core 107n with the idle state enabled.

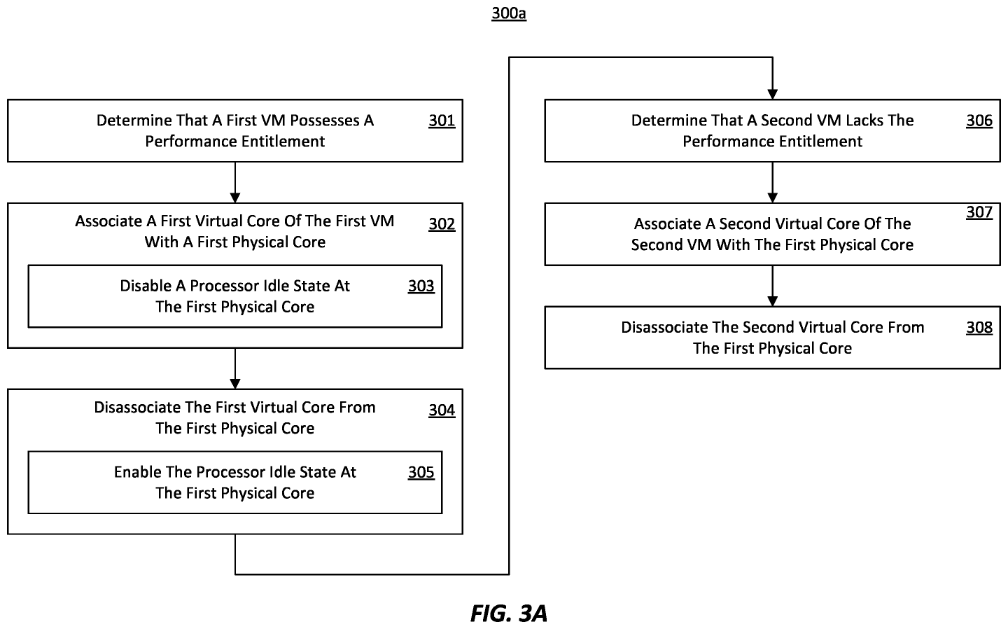

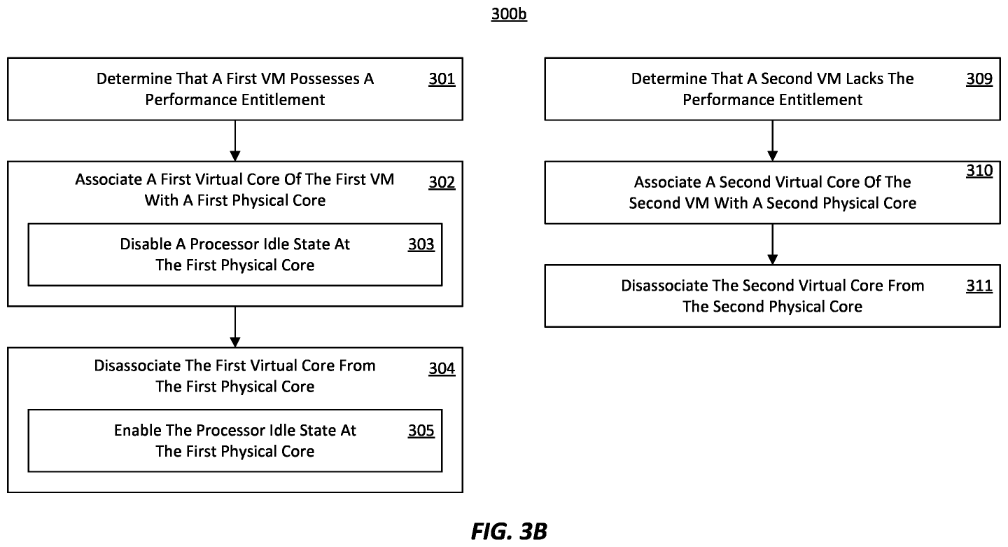

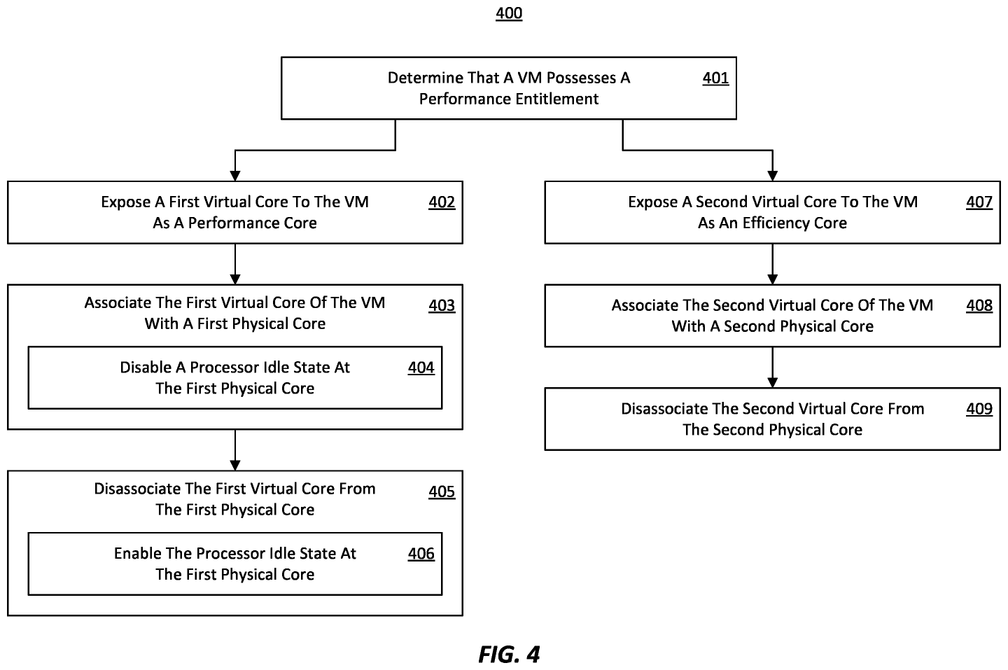

Embodiments are now described in connection with FIGS. 3A, 3B, and 4, which illustrate flow charts of example methods 300a, 300b, and 400 for managing a processor idle state based on a VM executing at a processor system. In embodiments, instructions for implementing methods 300a, 300b, and 400 are encoded as computer-executable instructions (e.g., representing processor manager 118) stored on a computer storage media (e.g., storage media 105) that are executable by a processor (e.g., processor system 103) to cause a computer system (e.g., computer system 101) to perform methods 300a, 300b, and 400.

The following discussion now refers to a number of methods and method acts. Although the method acts may be discussed in certain orders, or may be illustrated in a flow chart as occurring in a particular order, no particular ordering is required unless specifically stated, or required because an act is dependent on another act being completed prior to the act being performed.

Referring to FIGS. 3A and 3B, in embodiments, methods 300a, 300b each comprise an act 301 of determining that a first VM possesses a performance entitlement. In an example, entitlement component 201 determines that guest partition 111a possesses a performance entitlement (e.g., enlightenments 119 refer to guest partition 111a). As discussed, in embodiments, the performance entitlement is a low-latency entitlement, such that guest partition 111a corresponds to an LLVM.

Methods 300a, 300b also each comprise an act 302 of associating the first virtual core of the first VM with a first physical core, which includes an act 303 of disabling a processor idle state at the first physical core. In some embodiments, acts 302, 303 comprise, associating a virtual processor core of the VM with a physical processor core, including disabling a processor idle state at the physical processor core based on the VM possessing the performance entitlement. In an example, and referring to FIG. 1B, processor association component 202 makes an association between virtual core 115a and physical core 107a. Based on guest partition 111a possessing the performance entitlement, and based on this association, idle state component 203 disables an idle state at physical core 107a (e.g., the box within idle state setting 108a is not checked). An effect of disabling an idle state at physical core 107a in act 303 is to enable workloads issued to virtual core 115a by guest partition 111a to execute with reduced latency, as compared to a situation in which that idle state had been enabled at physical core 107a.

In some embodiments, disabling the idle state comprises the idle state component 203 disabling all idle states at physical core 107a. In other embodiments, disabling the idle state comprises the idle state component 203 disables a subset of idle states, such as one or more idle states corresponding to a deep sleep. Thus, in embodiments, the processor idle state is a deep sleep idle state. In embodiments, the deep sleep idle state is a C3 or higher numbered C-state.

Notably, in methods 300a, 300b, there is no particular ordering between the association in act 302 and the idle state disabling in act 303. Thus, in various embodiments, disabling the processor idle state (e.g., in connection with associating the virtual processor core with the physical processor core) comprises one of disabling the processor idle state prior to associating the virtual processor core with the physical processor core, disabling the processor idle state concurrent with associating the virtual processor core with the physical processor core, or disabling the processor idle state after associating the virtual processor core with the physical processor core.

Methods 300a, 300b also each comprise an act 304 of disassociating the first virtual core from the first physical core, which includes an act 305 of enabling the processor idle state at the first physical core. In some embodiments, acts 304, 305 comprise, subsequent to disabling the processor idle state at the physical processor core, disassociating the virtual processor core from the physical processor core, including enabling the processor idle state at the physical processor core. In an example, and referring to FIG. 1C, processor association component 202 disassociates virtual core 115a from physical core 107a. Based on this disassociation, idle state component 203 enables an idle state at physical core 107a (e.g., the box within idle state setting 108a is now checked). An effect of enabling the idle state at physical core 107a in act 305 is to ensure that the idle state is enabled at physical core 107a when no virtual core of an LLVM is associated with physical core 107a.

Notably, in methods 300a, 300b, there is no particular ordering between the disassociation in act 304 and the idle state enabling in act 304. Thus, in various embodiments, enabling the processor idle state (e.g., in connection with disassociating the virtual processor core with the physical processor core) comprises one of enabling the processor idle state prior to disassociating the virtual processor core with the physical processor core, enabling the processor idle state concurrent with disassociating the virtual processor core with the physical processor core, or enabling the processor idle state after disassociating the virtual processor core with the physical processor core.

Referring now to FIG. 3A, and method 300a, illustrated is an embodiment in which a virtual core from a conventional VM is associated with physical core 107a from which virtual core 115a was disassociated in act 304.

Following acts 304, 305, method 300a also comprises an act 306 of determining that a second VM lacks the performance entitlement. In an example, entitlement component 201 determines that guest partition 111n does not possess a performance entitlement (e.g., enlightenments 119 do not refer to guest partition 111n).

Method 300a also comprises an act 307 of associating a second virtual core of the second VM with the first physical core. In some embodiments, act 307 comprises, subsequent to disassociating the first virtual processor core from the physical processor core, associating a second virtual processor core of a second VM with the physical processor core without disabling the processor idle state at the physical processor core based on the second VM lacking the performance entitlement. In an example, and referring to FIG. 1D, processor association component 202 makes an association between virtual core 116a and physical core 107a. Based on guest partition 111n lacking the performance entitlement, idle state component 203 retains the enabled idle state at physical core 107a, or enables the idle state if it was disabled (e.g., the box within idle state setting 108a is checked).

Method 300a also comprises an act 308 of disassociating the second virtual core from the first physical core. In an example, processor association component 202 may later disassociate virtual core 116a from physical core 107a. Here, idle state component 203 retains the enabled status of the idle state at physical core 107a.

Referring now to FIG. 3B, and method 300b, illustrated is an embodiment in which a virtual core from a conventional VM is associated with a different physical core than physical core 107a. Notably, in method 300b, there is no particular ordering specified between acts 301-305 and acts 309-311. Thus, in embodiments, acts 301-305 can be performed prior to acts 309-311, subsequent to acts 309-311, or at least partially in parallel with acts 309-311.

Method 300b comprises an act 309 of determining that a second VM lacks the performance entitlement. In an example, entitlement component 201 determines that guest partition 111n does not possess a performance entitlement (e.g., enlightenments 119 do not refer to guest partition 111n).

Method 300b also comprises an act 310 of associating a second virtual core of the second VM with a second physical core. In some embodiments, act 310 comprises associating a second virtual processor core of the second VM with a second physical processor core without disabling the processor idle state at the second physical processor core based on the second VM lacking the performance entitlement. In an example, and referring to FIG. 1B, processor association component 202 makes an association between virtual core 116a and physical core 107n. Based on guest partition 111n lacking the performance entitlement, idle state component 203 retains an enabled idle state at physical core 107a, or enables the idle state if it was disabled (e.g., the box within idle state setting 108a is checked).

Method 300b also comprises an act 311 of disassociating the second virtual core from the second physical core. In an example, processor association component 202 may later disassociate virtual core 116a from physical core 107n. Here, idle state component 203 retains the enabled status of the idle state at physical core 107n.

It is noted that, because an idle state is disabled at physical core 107a but enabled at physical core 107n, it is possible (e.g., due to thermal considerations) that physical core 107a can utilize a higher clock rate than would be possible if the idle state was also disabled at physical core 107n. Thus, in some embodiments of method 300b, the first physical processor core utilizes a higher clock rate than if the processor idle state was disabled at the second physical processor core.

Additionally, it is noted that, in either of act 307 of method 300a or act 310 of method 300b, it is possible that the idle state had previously been disabled at the associated physical core. Thus, in embodiments, methods 300a, 300b include associating the second virtual processor core with the physical processor core, including enabling the processor idle state at the physical processor core based on the second VM lacking the performance entitlement.

As described in connection with FIG. 1E, in embodiments, an LLVM has virtual processors associated with a mix of physical cores having the idle state enabled and disabled, and topology component 204 presents, e.g., a “big.little” processor configuration to the LLVM. Turning to FIG. 4, this is further illustrated in method 400. In embodiments, method 400 comprises an act 401 of determining that a VM possesses a performance entitlement. In an example, and referring to FIG. 1E, entitlement component 201 determines that guest partition 111a possesses a performance entitlement (e.g., enlightenments 119 refer to guest partition 111a). As discussed, in embodiments, the performance entitlement is a low-latency entitlement, such that guest partition 111a corresponds to an LLVM.

Following the branch from act 401 to act 402, method 400 also comprises an act 402 of exposing a first virtual core to the VM as a performance core. In an example, and referring to FIG. 1E, topology component 204 exposes physical core 107a to guest OS 112 as a performance core. Notably while, for convenience in description, act 402 appears prior to acts 403/404, in some embodiments act 402 could appear after acts 403/404, or even prior to act 401.

Method 400 also comprises an act 403 of associating the first virtual core of the VM with a first physical core, which includes an act 404 of disabling a processor idle state at the first physical core. In an example, and referring to FIG. 1E, processor association component 202 makes an association between virtual core 115a and physical core 107a. Based on guest partition 111a possessing the performance entitlement, and based on this association, idle state component 203 disables an idle state at physical core 107a (e.g., the box within idle state setting 108a is not checked).

Method 400 also comprises an act 405 of disassociating the first virtual core from the first physical core, which includes an act 406 of enabling the processor idle state at the first physical core. In an example, and referring to FIG. 1E, processor association component 202 disassociates virtual core 115a from physical core 107a. Based on this disassociation, idle state component 203 enables the idle state at physical core 107a.

Returning to act 401, and following the branch from act 401 to act 407, method 400 also comprises an act 407 of exposing a second virtual core to the VM as an efficiency core. In an example, and referring to FIG. 1E, topology component 204 exposes virtual core 115n to guest OS 112 as an efficiency core. Notably while, for convenience in description, act 407 appears prior to act 408, in some embodiments act 407 could appear after act 408, or even prior to act 401.

Method 400 also comprises an act 408 of associating the second virtual core of the VM with a second physical core. In some embodiments, act 408 comprises associating a second virtual processor core of the VM with a second physical processor core without disabling the processor idle state at the second physical processor core. In an example, and referring to FIG. 1E, processor association component 202 makes an association between virtual core 115n and physical core 107n, without idle state component 203 disabling the idle state at physical core 107n (e.g., the box within idle state setting 108n is checked).

Method 400 also comprises an act 409 of disassociating the second virtual core from the second physical core. In an example, and referring to FIG. 1E, processor association component 202 may later disassociate virtual core 115n from physical core 107n. Here, idle state component 203 retains the enabled status of the idle state at physical core 107n.

Notably, in method 400, there is no particular ordering specified between acts 402-406 and acts 407-409. Thus, in embodiments, acts 402-406 can be performed prior to acts 407-409, subsequent to acts 407-409, or at least partially in parallel with acts 407-409.

In embodiments, based on method 400, guest OS 112 schedules higher-priority and/or latency-sensitive workloads to virtual core 115a (where they are processed by physical core 107a with the idle state disabled), and schedules lower-priority and/or latency tolerant workloads to virtual core 115n (where they are processed by physical core 107n with the idle state enabled).

It is noted that, because the idle state is disabled at physical core 107a, but enabled at physical core 107n, it is possible (e.g., due to thermal considerations) that physical core 107a can utilize a higher clock rate than would be possible if the idle state was also disabled at physical core 107n. Thus, in some embodiments of method 400, the first physical processor core utilizes a higher clock rate than if the processor idle state was disabled at the second physical processor core.

Embodiments of the disclosure may comprise or utilize a special-purpose or general-purpose computer system (e.g., computer system 101) that includes computer hardware, such as, for example, a processor system (e.g., processor system 103) and system memory (e.g., memory 104), as discussed in greater detail below. Embodiments within the scope of the present disclosure also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media (e.g., storage media 105). Computer-readable media that carry computer-executable instructions and/or data structures are transmission media. Thus, by way of example, embodiments of the disclosure can comprise at least two distinctly different kinds of computer-readable media: computer storage media and transmission media.

Computer storage media are physical storage media that store computer-executable instructions and/or data structures. Physical storage media include computer hardware, such as random access memory (RAM), read-only memory (ROM), electrically erasable programmable ROM (EEPROM), solid state drives (SSDs), flash memory, phase-change memory (PCM), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., network interface 106), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

It will be appreciated that the disclosed systems and methods may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. Embodiments of the disclosure may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

It will also be appreciated that the embodiments of the disclosure may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). A cloud computing model can be composed of various characteristics, such as on-demand self-service, broad network access, resource pooling, rapid elasticity, measured service, and so forth. A cloud computing model may also come in the form of various service models such as, for example, Software as a Service (Saas), Platform as a Service (PaaS), and Infrastructure as a Service (IaaS). The cloud computing model may also be deployed using different deployment models such as private cloud, community cloud, public cloud, hybrid cloud, and so forth.

Some embodiments, such as a cloud computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

The present disclosure may be embodied in other specific forms without departing from its essential characteristics. The described embodiments are to be considered in all respects only as illustrative and not restrictive. All changes which come within the meaning and range of equivalency of the claims are to be embraced within their scope.

When introducing elements in the appended claims, the articles “a,” “an,” “the,” and “said” are intended to mean there are one or more of the elements. The terms “comprising,” “including,” and “having” are intended to be inclusive and mean that there may be additional elements other than the listed elements. Unless otherwise specified, the terms “set,” “superset,” and “subset” are intended to exclude an empty set, and thus “set” is defined as a non-empty set, “superset” is defined as a non-empty superset, and “subset” is defined as a non-empty subset. Unless otherwise specified, the term “subset” excludes the entirety of its superset (i.e., the superset contains at least one item not included in the subset). Unless otherwise specified, a “superset” can include at least one additional element, and a “subset” can exclude at least one element.

What is claimed:

1. A method, implemented at a computer system that includes a processor system, comprising:
determining that a virtual machine (VM) possesses a performance entitlement;
associating a virtual processor core of the VM with a physical processor core, including disabling a processor idle state at the physical processor core based on the VM possessing the performance entitlement; and
disassociating the virtual processor core from the physical processor core, including enabling the processor idle state at the physical processor core.

2. The method of claim 1, wherein the processor idle state is a deep sleep idle state.

3. The method of claim 2, wherein the deep sleep idle state is a C3 or higher numbered C-state.

4. The method of claim 1, wherein disabling the processor idle state comprises one of:
disabling the processor idle state prior to associating the virtual processor core with the physical processor core;
disabling the processor idle state concurrent with associating the virtual processor core with the physical processor core; or
disabling the processor idle state after associating the virtual processor core with the physical processor core.

5. The method of claim 1, wherein the virtual processor core is a first virtual processor core, the physical processor core is a first physical processor core, and the VM is a first VM, the method further comprising:
determining that a second VM lacks the performance entitlement; and
based on the second VM lacking the performance entitlement, associating a second virtual processor core of the second VM with a second physical processor core without disabling the processor idle state at the second physical processor core.

6. The method of claim 5, further comprising, associating the second virtual processor core with the second physical processor core, including enabling the processor idle state at the second physical processor core based on the second VM lacking the performance entitlement.

7. The method of claim 5, wherein the first physical processor core utilizes a higher clock rate than if the processor idle state was disabled at the second physical processor core.

8. The method of claim 1, further comprising exposing the virtual processor core to the VM as a performance core.

9. The method of claim 8, wherein the virtual processor core is a first virtual processor core and the physical processor core is a first physical processor core, the method further comprising:
associating a second virtual processor core of the VM with a second physical processor core without disabling the processor idle state at the second physical processor core; and
exposing the second virtual processor core to the VM as an efficiency core.

10. The method of claim 9, wherein the first physical processor core utilizes a higher clock rate than if the processor idle state was disabled at the second physical processor core.

11. A computer system comprising:
a processor system; and
a computer storage media that stores computer-executable instructions that are executable by the processor system to at least:
associate a first virtual processor core of a first virtual machine (VM) with a physical processor core of the processor system, including disabling a processor idle state at the physical processor core based on the first VM possessing a performance entitlement;
subsequent to disabling the processor idle state at the physical processor core, disassociate the first virtual processor core from the physical processor core, including enabling the processor idle state at the physical processor core; and
subsequent to disassociating the first virtual processor core from the physical processor core, associate a second virtual processor core of a second VM with the physical processor core without disabling the processor idle state at the physical processor core based on the second VM lacking the performance entitlement.

12. The computer system of claim 11, wherein the processor idle state is a deep sleep idle state.

13. The computer system of claim 12, wherein the deep sleep idle state is a C3 or higher numbered C-state.

14. The computer system of claim 11, wherein disabling the processor idle state comprises one of:
disabling the processor idle state prior to associating the first virtual processor core with the physical processor core;
disabling the processor idle state concurrent with associating the first virtual processor core with the physical processor core; or
disabling the processor idle state after associating the first virtual processor core with the physical processor core.

15. The computer system of claim 11, the computer-executable instructions also executable by the processor system to, associate the second virtual processor core with the physical processor core, including enabling the processor idle state at the physical processor core based on the second VM lacking the performance entitlement.

16. The computer system of claim 11, the computer-executable instructions also executable by the processor system to expose the first virtual processor core to the first VM as a performance core.

17. The computer system of claim 16, wherein the physical processor core is a first physical processor core, the computer-executable instructions also executable by the processor system to:
associate a third virtual processor core of the first VM with a second physical processor core without disabling the processor idle state at the second physical processor core; and
expose the third virtual processor core to the first VM as an efficiency core.

18. A computer program product comprising a computer storage media that stores computer-executable instructions that are executable by a processor system to at least:
based on a first virtual machine (VM) possessing a performance entitlement:
associate a first virtual processor core of the first VM with a first physical processor core of the processor system, including disabling a processor idle state at the first physical processor core, and
subsequent to disabling the processor idle state at the first physical processor core, disassociate the first virtual processor core from the first physical processor core, including enabling the processor idle state at the first physical processor core; and
associate a second virtual processor core of a second VM with a second physical processor core of the processor system without disabling the processor idle state at the second physical processor core based on the second VM lacking the performance entitlement.

19. The computer program product of claim 18, wherein the processor idle state is a deep sleep idle state.

20. The computer program product of claim 18, wherein disabling the processor idle state at the first physical processor core comprises one of:
disabling the processor idle state prior to associating the first virtual processor core with the first physical processor core;
disabling the processor idle state concurrent with associating the first virtual processor core with the first physical processor core; or
disabling the processor idle state after associating the first virtual processor core with the first physical processor core.
